(19) United States
(12) Patent Application Publication
(10) Pub. No.: US 2020/0141305 A1
(43) Pub. Date: May 7, 2020

(54) A PISTON FOR AN INTERNAL COMBUSTION ENGINE

(71) Applicant: Scania CV AB, Södertälje (SE)

(72) Inventor: Henrik DEMBINSKI, Tyresö (SE)

(73) Assignee: Scania CV AB, Södertälje (SE)

(21) Appl. No.: 16/492,815

(22) PCT Filed: Feb. 27, 2018
(86) PCT No.: PCT/SE2018/050185

§ 371 Date: Sep. 10, 2019

(30) Foreign Application Priority Data
Mar. 17, 2017 (SE) 1750321-0

(51) Int. Cl. F02B 23/06

(52) U.S. Cl. CPC F02B 23/0624; F02B 23/0651; F02F 3/24; F02B 23/0696; F02B 23/0672

(57) ABSTRACT

Method, control unit, and target arrangement of a leading vehicle for triggering a follower vehicle, which is situated at a lateral distance from the leading vehicle, to coordinate its movements with the leading vehicle. The target arrangement comprises a target configured to be placed at a lateral distance from to the leading vehicle. The target is also configured to be recognized by at least one forwardly directed sensor of the follower vehicle.

### CROSS-REFERENCE TO RELATED APPLICATION(S)

This application is a national stage application (filed under 35 § U.S.C. 371) of PCT/SE2018/050185, filed Feb. 27, 2018 of the same title, which, in turn, claims priority to Swedish Application No. 1750321-0 filed Mar. 17, 2017; the contents of each of which are hereby incorporated by reference.

### FIELD OF THE INVENTION

The present invention relates to a piston for an internal combustion engineand to an internal combustion engine comprising at least one cylinder with such a piston. It also relates to a motor vehicle comprising an internal combustion engine and to a method for creating a swirl motion in a combustion chamber of a cylinder in an internal combustion engine.

While the piston is primarily discussed with respect to diesel engines, it is to be understood that the piston may be used in any kind of internal combustion engine in which fuel or other fluids is/are directly injected into a combustion chamber, for example by means of injection of fuel followed by fuel ignition to provide piston movement. The piston may e.g. be used in two-stroke and four-stroke engines such as Otto engines, homogeneous charge compression ignition (HCCI) engines, and reactivity controlled compression ignition (RCCI) engines.

The internal combustion engine may also be a stationary internal combustion engine used in e.g. a pump or an electric generator.

### BACKGROUND OF THE INVENTION

Internal combustion engines such as diesel engines, also known as compression-ignition engines, and Otto engines, or spark-ignition engines, are commonly used in different types of motor vehicles, such as trucks and buses, cars, vessels, etc. Internal combustion engines are also used in many industrial applications.

Internal combustion engines, hereinafter also referred to as engines, may be driven by a plurality of different types of fuel, such as diesel, petrol, ethanol, gaseous fuel, and biofuel. The engines have a number of cylinders in which a reciprocating piston is provided. In an upper end of the piston, a piston bowl is provided. Together with an upper part of the cylinder and a cylinder head, the piston bowl forms a combustion chamber in which fuel is injected and combusted. The piston bowl is designed to contribute to mixing of air and fuel and to create a flow pattern influencing combustion and emission formation within the combustion chamber.

In a diesel engine, the fuel is normally injected during a powerstroke of the piston. The fuel is ignited by the compression heat and combusted almost immediately following injection. Air and fuel must therefore be mixed in a very short time, and it is desirable to ensure that the mixing is efficient and that the fuel becomes well-distributed within the combustion chamber so as to achieve a complete combustion. During the combustion, large amounts of soot are created due to the lack of oxygen in the non-pre-mixed diesel flame. The time between end of injection and exhaust valve opening is thereby critical to oxidize remaining soot particles in the cylinder. Four important parameters control the soot oxidation during this so called post-oxidation phase, namely time, temperature, oxygen and turbulence. The amount of soot particles present in the exhaust gases can thereby be minimized by controlling those parameters.

Increasingly stringent emission regulations, relating primarily to soot and nitrogen oxide (NOx) emissions, make it necessary to aim at further improving the emission control of internal combustion engines. However, more efficient emission control often require more complex and energy demanding aftertreatment and combustion systems, contributing to an increased fuel consumption. For example, a swirl motion may be created to form turbulence in the combustion chamber and efficiently mix fuel with air. The swirl motion is a large scale swirling motion around the axis of the cylinder, which is typically created during the intake stroke of the piston by the intake ports. The swirl motion improves the combustion conditions and increases the turbulence in the post-oxidation phase, thereby reducing the emission levels. However, the creation of swirl motion during the intake stroke is energy demanding and also increases heat transfer to the walls of the combustion chamber during the subsequent compression stroke. Thus, the creation of swirl motion by intake ports during the intake stroke generally reduces the efficiency of the engine. On the other hand, if the intake ports are designed not to create swirl, the soot emission levels may increase and thereby the demands on e.g. higher injection pressure or diesel particulate filters (DPF) provided downstream of the engine. Such higher injection pressures and filters generally increase production costs and fuel consumption.

There are known solutions for improving the mixture of air/fuel by modification of the piston bowl. For example, FR2898638 discloses a piston for an internal combustion engine, having a piston bowl in which a propeller-like bottom structure is provided. The bottom structure creates a swirl motion in the combustion chamber upon injection of fuel. However, there is a risk that fuel gets obstructed within cavities in the bottom structure, thus leading to insufficient mixing of air and fuel. Soot and hydrocarbons (HC) may thereby be created and increase the emission levels.

US2011/0253095 discloses a piston for an internal combustion engine, having a piston bowl in which a plurality of protrusions are provided, protruding from a side wall of the piston bowl. Fuel is injected into the combustion chamber and is redirected upon impacting with the protrusions such that a rotational motion may be induced.

However, there is a need for a further improved piston that enables a combination of efficient combustion, a limited heat transfer to the walls of the combustion chamber, and reduced emission levels.

### SUMMARY OF THE INVENTION

It is a first objective of the present invention to provide a piston for an internal combustion engine which has a piston bowl configured to improve the efficiency of the combustion and post-oxidation phase, to reduce emission levels and to enable reduction of heat transfer to the walls of the combustion chamber. A second objective is to provide an internal combustion engine with an improved efficiency and reduced emission levels, thus reducing the need for extremely high injection pressures, diesel particulate filters and similar. A third objective is to provide an in at least some aspect improved and less energy consuming method for creating a swirl motion in a combustion chamber that survives into the post-oxidation phase.

At least the first objective is achieved by means of the initially defined piston for an internal combustion engine, where the piston bowl further comprises:

an annular ridge formed in a transition between the annular upper side wall portion and the annular lower side wall portion, projecting toward the central axis, a plurality of angularly spaced protrusions, protruding toward the central axis from the annular upper side wall portion, each protrusion having a concave surface portion, wherein the piston bowl is configured so that a fluid spray injected toward a target position located below one of said angularly spaced protrusions is split by the annular ridge into an upper flow portion and a lower flow portion, wherein the upper flow portion is deflected by the concave surface portion of the protrusion located above the target position so that it contributes to creation of a swirl motion in the combustion chamber.

The piston according to the invention has a piston bowl configured to deflect a portion of the fluid spray such that a swirl motion in the piston bowl is created and the mixing of air and fuel is improved. The swirl motion may hereby be induced during injection of e.g. fuel into the combustion chamber, and the swirl motion will survive into the post-oxidation phase of the combustion. The swirl motion may be created independently of the design of the intake ports. Thus, the energy required to create the swirl motion may be reduced. Moreover, heat transfer to the walls of the combustion chamber may be reduced during the compression stroke of the cylinder when swirl is not created during the intake stroke. The improved mixing of fuel and air also leads to lower emission levels including less soot particles, and may thereby reduce the need for expensive and energy demanding increased injection pressures and/or diesel particulate filters. Moreover, the angularly spaced protrusions, which may be identical, delimit the flame and reduce its size, thereby delimiting the surface area of the flame which is exposed to unburned oxygen and nitrogen. Since NOx gases are primarily created at the surface of the flame, the smaller flame results in reduced levels of NOx emissions. The proposed piston is thereby useful for improving energy efficiency and reducing both soot and NOx emission levels of an internal combustion engine.

The configuration with the annular ridge located below the protrusions makes it possible to, upon injection, direct the fluid spray such that the fluid spray, or, in the case where the fluid spray is a fuel spray which is ignited upon injection, the flame, may be split on the annular ridge. The upper flow portion of the fluid spray/flame is deflected toward the concave surface portion of the above protrusion, and the lower flow portion of the fluid spray/flame may be deflected into an annular channel delimited by the annular bottom and the annular lower side wall portion. The upper flow portion of the fluid spray/flame, which is deflected by the concave surface portion, may be deflected toward a position above the annular ridge, so that a swirl motion is induced in an upper part of the combustion chamber. This may further improve the mixing of fuel and air due to velocity gradients.

During the post oxidation phase, the large scale swirl created in the combustion chamber may be fractured into small scale turbulence leading to accelerated soot oxidation and thereby lower soot emissions. The fracture of the large scale swirling motion to small scale turbulence is possible thanks to the velocity differences in the piston bowl, created by the large scale swirl motion during the combustion phase.

Since the swirl motion may with the proposed piston be created upon injection of fuel, the rotational speed of the fuel/air mixture becomes proportional to the fuel injection pressure. Thus, the swirl motion scales with the fuel injection pressure and is thereby adapted to the operating conditions of the internal combustion engine.

The fuel spray may typically be ignited a very short time after injection into the combustion chamber, i.e. after an ignition delay. Upon ignition, a flame is formed. However, the injected fluid spray does not necessarily have to be a fuel spray, but may also be a mixture of fuel/gas or a liquid spray which is injected primarily to create a swirl motion, either during the compression stroke or during the power stroke of the piston. For example, injection of fluid in the form of water may reduce the combustion temperature and thereby reduce NOx emissions. In e.g. an Otto engine, a fuel/air mixture may be injected during the compression stroke such that a swirl motion is created before ignition of the fuel/air mixture using a spark plug. The fluid spray may also be injected during the power stroke to improve the conditions during the post-oxidation phase.

Of course, it is possible to combine the piston according to the invention with intake ports configured to create a swirl motion during the intake stroke, in order to further increase the turbulence in the combustion chamber. The swirl created by the intake ports can either be in the same direction as the fluid injection induced swirl, or be in the form of a counterflow.

According to one embodiment, the concave surface portion of each of the angularly spaced protrusions is configured to face radially inward. Fuel can thereby be efficiently redirected to create a swirl motion.

According to one embodiment, the concave surface portion of each of the angularly spaced protrusions is configured so that at least a part of the upper flow portion is redirected toward a position above the annular ridge. The swirl motion may thereby be induced in an upper part of the combustion chamber located above the annular ridge. If the lower flow portion is deflected from the annular ridge toward an annular channel discussed above at the bottom of the piston bowl, the mixing of fuel and air is further improved.

According to one embodiment, each of the angularly spaced protrusions has an innermost point located at a similar radial distance from the central axis as the annular ridge. By “innermost point” is herein intended the point closest to the central axis, i.e. the point that protrudes the most from the annular upper side wall portion. By “similar radial distance” is herein intended a distance that does not differ by more than 10% from the radial distance between an innermost point of the annular ridge to the central axis. In this embodiment, the ignition delay may be optimized for reduction of both NOx gases and soot particles. It is also possible to make the protrusions extend to a position closer to the central axis, in which case a shorter ignition delay can be expected, with a resulting reduced amount of NOx gases and an increased amount of soot. If the protrusions are instead made to extend to a position further away from the central axis, the opposite can be expected.

According to one embodiment, the annular lower side wall portion is in the form of a concave surface free from protrusions. This reduces the risk that fuel gets obstructed in the lower part of the piston bowl and improves the conditions for mixing of fuel/air in the lower part of the combustion chamber with the rotating fuel/air within the upper part of the combustion chamber.

According to one embodiment, each of the angularly spaced protrusions further comprises a convex surface portion located opposite the concave surface portion. The upper flow portion may thereby be split on an innermost edge of the protrusion and while one part of the upper flow portion follows the concave surface portion, another part follows the convex surface portion, both parts contributing to the creation of the swirl motion.

According to one embodiment, the central bottom portion has a highest point located on the central axis, from which highest point the central bottom portion slopes downward toward the annular bottom portion. This configuration increases the compression achieved in the combustion chamber during the compression stroke. Furthermore, air is pressed into the periphery of the combustion chamber where combustion takes place. The central bottom portion preferably has a conical or an essentially conical shape. The highest point of the central portion may be located at an axial level on or above an axial level of the annular ridge.

At least the second objective is achieved by means of an internal combustion engine comprising at least one cylinder with the proposed piston. Advantages and advantageous features of such a combustion engine appear from the above description of the proposed piston. Of course, the internal combustion engine may comprise a plurality of cylinders having the proposed piston. The internal combustion engine may be adapted for use within a motor vehicle or within a stationary machine such as a pump or an electrical generator.

According to one embodiment, the internal combustion engine further comprises an injector configured to inject and direct a fluid spray toward a plurality of target positions, wherein each target position is located below one of said angularly spaced protrusions. Each target position is associated with one of the angularly spaced protrusions and is located directly below the associated protrusion. The internal combustion engine is thereby configured to create a swirl motion upon injection of fluid in the form of e.g. fuel, air, water or mixtures thereof. Preferably, the injector may be positioned on the central axis.

The invention also relates to a motor vehicle comprising the proposed internal combustion engine. The motor vehicle may be a heavy motor vehicle such as a truck or a bus, but it may also be e.g. a passenger car or another motor vehicle.

At least the third objective is achieved by means of a method for creating a swirl motion in a combustion chamber of a cylinder in the proposed internal combustion engine, comprising:

providing a flow of air into the combustion chamber during an intake stroke of the piston, during or after a compression stroke of the piston, injecting a fluid spray toward the plurality of target positions, so that the fluid spray is at each one of the target positions split by the annular ridge into an upper flow portion and a lower flow portion, wherein the upper flow portion is deflected by the concave surface portion of the protrusion located above the target position so that a swirl motion is created in the combustion chamber.

Advantages of the method appear from the above description of the proposed piston.

According to one embodiment, injecting a fluid spray comprises, following a compression stroke of the piston, injecting a fuel spray so that when the fuel spray is ignited and a flame is formed, at least an upper flow portion of the flame is deflected by the concave surface portion so that a swirl motion is created in the combustion chamber. This is applicable for diesel engines, in which the fuel spray is ignited almost immediately upon injection.

According to one embodiment, the flow of air into the combustion chamber is provided without creating a swirl motion. The swirl motion is thereby created entirely upon injection of fluid and the amount of energy required for creating the swirl motion is reduced. It is however also possible to combine creation of a swirl motion during the intake stroke with creation of a swirl motion upon injection of fluid, for further enhancing turbulence in the combustion chamber.

Further advantages as well as advantageous features of the present invention will appear from the following detailed description.

### BRIEF DESCRIPTION OF THE DRAWINGS

Embodiments of the invention will in the following be described with reference to the appended drawings, in which:

FIG. 1 schematically shows an axial section of a cylinder of an internal combustion engine according to an embodiment,

FIG. 2 is a perspective view of a piston according to a first embodiment,

FIG. 3 is an upper end view of the piston in FIG. 2,

FIG. 4 is a section taken along the line IV-IV in FIG. 2,

FIG. 5 is a section taken along the line V-V in FIG. 2,

FIG. 6 is a perspective view of a piston according to a second embodiment,

FIG. 7 is an upper end view of the piston in FIG. 6,

FIG. 8 is a section taken along the line VIII-VIII in FIG. 6,

FIG. 9 is a section taken along the line IX-IX in FIG. 6, and

FIG. 10 is a cross section taken along the line X-X in FIG. 9 shown together with a diagram showing rotational speed within a combustion chamber as a function of distance from a central axis.

### DETAILED DESCRIPTION OF THE INVENTION

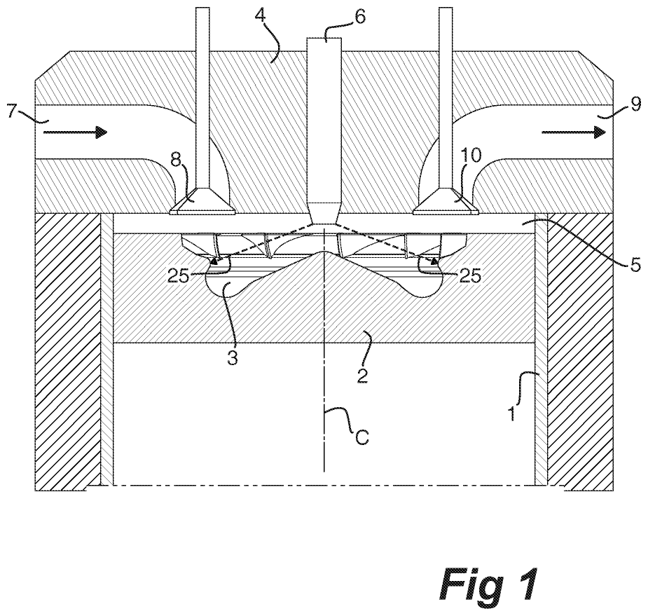

FIG. 1 shows a section taken along a central axis C of a cylinder 1 of an internal combustion engine in the form of a diesel engine according to an embodiment of the invention. In the cylinder 1, a piston 2 configured to reciprocate within the cylinder along the common central axis C is provided. A piston bowl 3 is formed in the piston 2, which together with internal walls of the cylinder 1 and an internal surface of a cylinder head 4 creates a combustion chamber 5. A fuel injector 6 is positioned on the central axis C above the piston bowl 3. An intake port 7 is provided in the cylinder head 4 for supply of air into the combustion chamber 5 via an intake valve 8. Furthermore, an exhaust port 9 is provided in the cylinder head 4 for evacuation of exhaust gases via an exhaust valve 10.

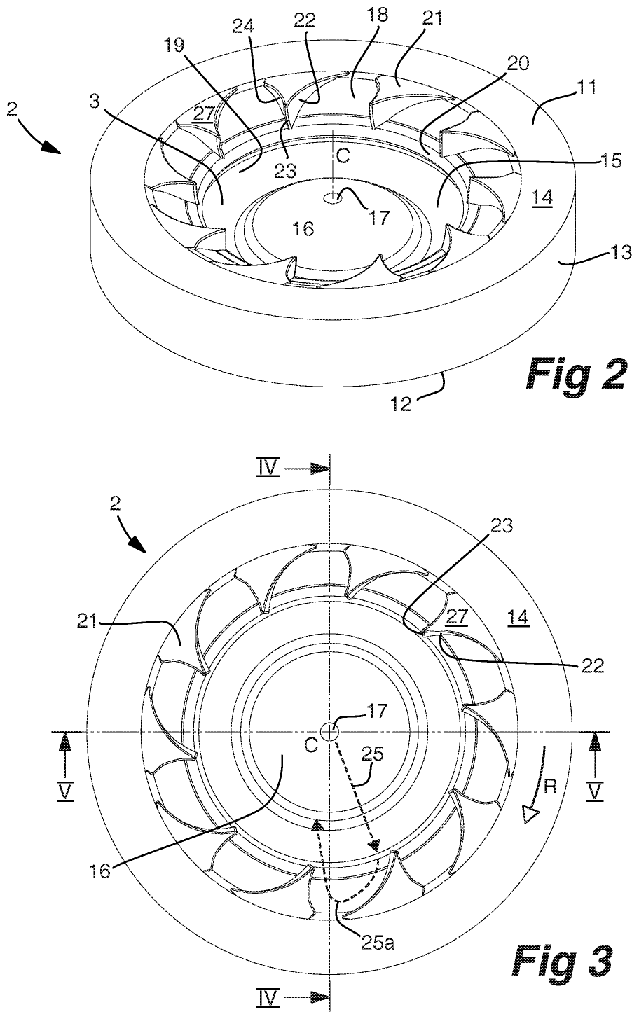

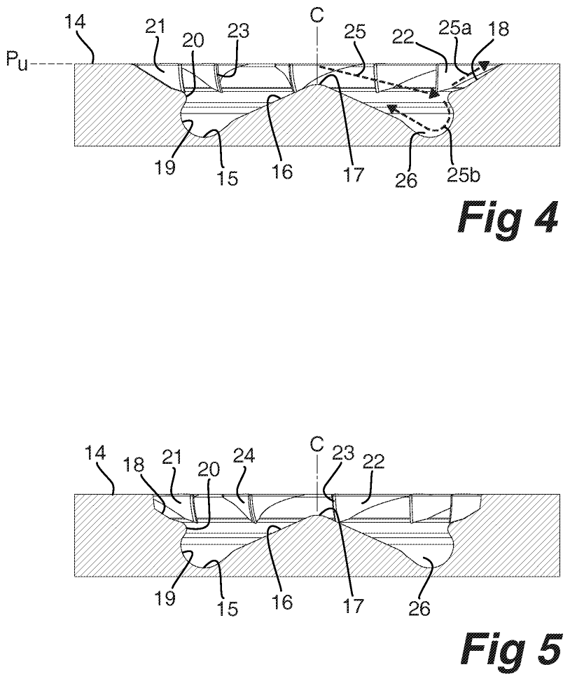

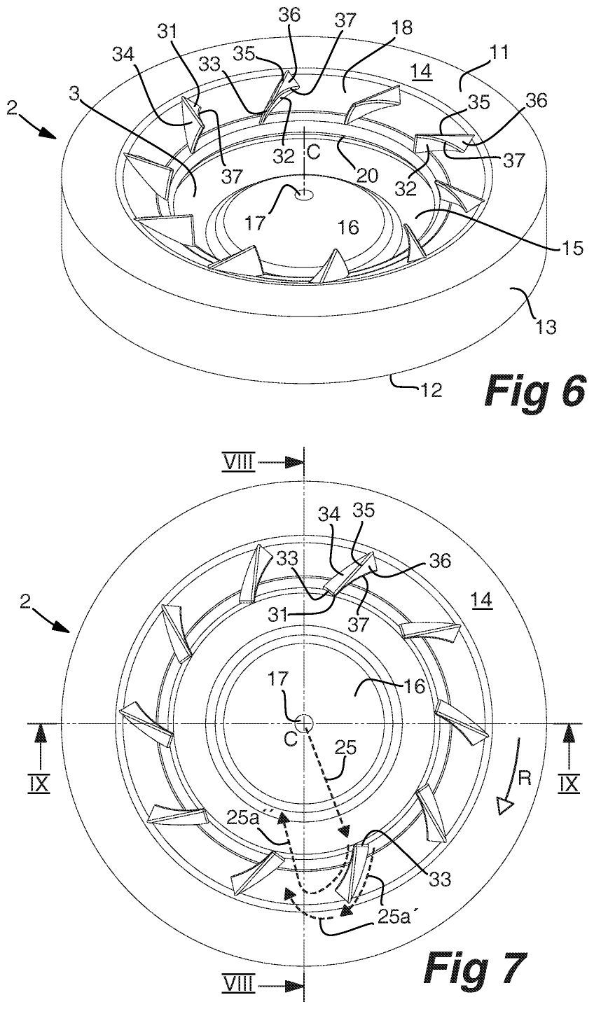

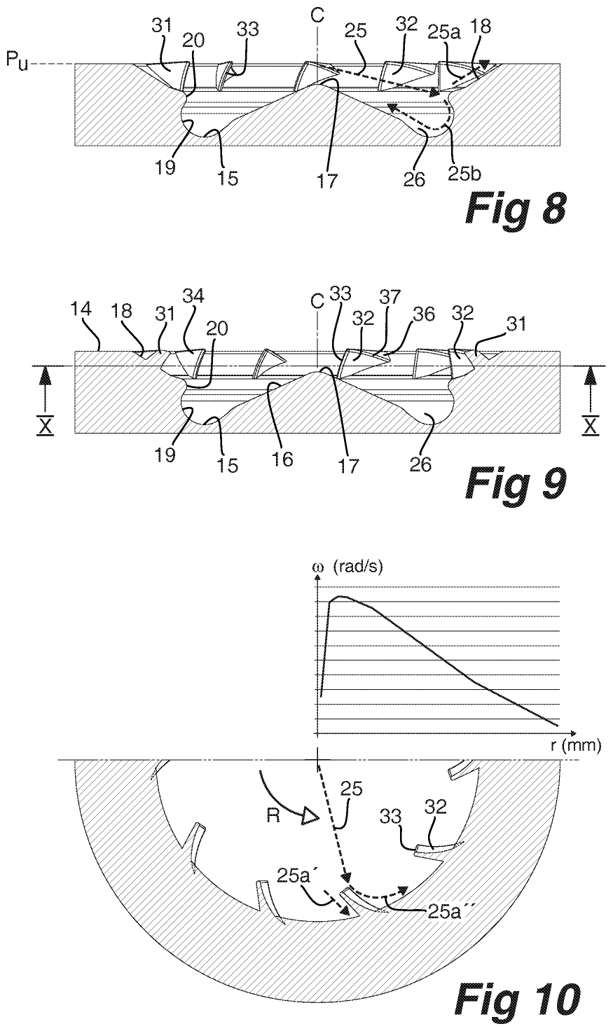

The piston 2 according to the embodiment shown in FIG. 1 is shown in closer detail in FIGS. 2-5. A piston 2 according to a second embodiment is shown in FIGS. 6-10. Common elements of the piston 2 according to the first and the second embodiment will in the following be described using common reference numerals.

The piston 2 according to both embodiments has the basic shape of a right circular cylinder with an upper end 11 and a lower end 12, between which a central axis C and a peripheral envelope surface 13 extend. The upper end 11 comprises an annular top surface 14 defining an upper plane Pᵤ. The piston bowl 3 is recessed with respect to the upper plane Pᵤ defined by the top surface 14. An annular bottom portion 15 defines a lowest level of the piston bowl 3. Radially inside of the annular bottom portion 15, a central bottom portion 16 which is elevated with respect to the lowest level is provided. The central bottom portion 16 is cone shaped with a rounded top 17, which top 17 is recessed with respect to the upper plane Pᵤ. An annular upper side wall portion 18 extends downward and radially inward from the top surface 11. An annular lower side wall portion 19 extends upward from the annular bottom portion 15 toward the upper side wall portion 18. Between the upper side wall portion 18 and the lower side wall portion 19, an annular ridge 20 is formed, projecting toward the central axis C. Together, the annular bottom portion 15 and the lower side wall portion 19 delimit an annular channel 26 surrounding the central bottom portion 16.

The fuel injector 6 is configured for injecting fuel into the cylinder 1 as a fuel spray 25 so that the fuel is mixed with air compressed in the cylinder 1 to form a fuel/air mixture. The fuel/air mixture is after an ignition delay ignited by compression heat generated in the cylinder 1. The ignited part of the fuel spray 25 forms a flame. The fuel can be injected with different injection pressures, from low to very high pressures. The fuel injector 6 includes a plurality of small injection orifices (not shown), formed in the lower end of a nozzle assembly of the fuel injector 6 for permitting the high pressure fuel to flow from a nozzle cavity of the fuel injector 6 into the combustion chamber 5 with high pressure to induce thorough mixing of the fuel with the hot compressed air within the combustion chamber 5. It should be understood that the fuel injector 6 may be any type of fuel injector capable of injecting high pressure fuel through a plurality of injector orifices into the combustion chamber 5. Also, the fuel injector need not necessarily be positioned on the central axis C.

In other embodiments, in which the internal combustion engine is e.g. an Otto engine, the fuel injector may be configured to inject a mixture of fuel and air into the combustion chamber. The injector may also be configured to inject other fluids such as gases or liquids, e.g. water, which are not combusted but are primarily used to induce a swirl motion.

In the first embodiment shown in FIGS. 2-5, a plurality of identical and angularly spaced protrusions 21 protrude toward the central axis C from the upper side wall portion 18 above target positions located on the ridge 20. Each protrusion 21 is wedge shaped with a first concave surface portion 22, which in the radial direction extends from the upper side wall portion 18 to a curved innermost edge 23 of the protrusion 21, whose innermost point is located closest to the central axis C at approximately the same distance from the central axis C as the annular ridge 20. In the axial direction, the protrusion extends from the top surface 14 to the ridge 20. The first concave surface portion 22 is directed so that no part of the concave surface portion 22 is hidden behind any part of the protrusion 21 as seen from the central axis C. The first concave surface portion 22 has a curvature both as seen in an upper end view such as in FIG. 3 and in a sectional view across the protrusion 21, such as shown in FIG. 5. Each protrusion 21 further has a smaller second concave surface portion 24 located opposite the first concave surface portion 22 and a planar upper surface portion 27 at the level of the upper plane Pᵤ.

The injection orifices of the fuel injector 6 are arranged so that the fuel spray 25 is injected toward target positions on, above or below the annular ridge 20, which target positions are located below the first concave surface portions 22 of the protrusions 21. It should be noted that the piston 2 is moving along the central axis C as the fuel spray 25 is injected, and therefore the exact target positions in the axial direction will vary. The target position aimed for in the axial direction also depends on e.g. load and injection timing. As the ignited fuel spray 25, i.e. the flame, strikes the target positions, the flame is split on the annular ridge 20 into an upper flow portion 25a and a lower flow portion 25b. The upper flow portion 25a of the flame is deflected upward, toward the concave surface portion 22. The lower flow portion 25b of the flame is deflected downward, into the annular channel 26 and toward the central bottom portion 16. As the upper flow portion 25a impinges on the concave surface portion 22, it is deflected toward a position in an upper part of the combustion chamber 5, above the annular ridge 20, which position is angularly spaced from the concave surface portion 22 by which the flame was deflected. The deflected upper flow portions 25a of the flames thereby together induce a swirl motion in the upper part of the combustion chamber 5, i.e. a large scale rotation in the direction of rotation R around the central axis C. Between a lower part of the combustion chamber 5, below the annular ridge 20, and the upper part of the combustion chamber 5, turbulence may be created as the rotating flow of fuel/air mixture in the upper part of the combustion chamber 5 interacts with the fuel/air mixture in the lower part of the combustion chamber 5, which rotates with an axis of rotation perpendicular to or essentially perpendicular to the central axis C.

In the second embodiment shown in FIGS. 6-10, a plurality of mutually identical and angularly spaced protrusions 31 protrude toward the central axis C from the upper side wall portion 18 above target positions located on the ridge 20. The protrusions 31 are in the form of fins having a concave surface portion 32, which in the radial direction extends from the upper side wall portion 18 to a curved innermost edge 33 of the protrusion 31, whose innermost point is located at the level of the upper plane Pᵤ, closest to the central axis C at approximately the same distance from the central axis C as the annular ridge 20. In the axial direction, the protrusion extends from the top surface 14 to the ridge 20. The concave surface portion 32 is directed so that no part of the concave surface portion 32 is hidden behind any part of the protrusion 31 as seen from the central axis C. The concave surface portion 32 has a curvature both as seen in a transverse cross sectional view such as in FIG. 10 and in an axial sectional view across the protrusion 31, such as shown in FIG. 9. Each protrusion 31 further has a convex surface portion 34 located opposite the first concave surface portion 32, extending from the upper side wall portion 18 to the innermost edge 33. The protrusion 31 has an upper edge 35 extending in the upper plane Pᵤ. An inclined surface 36 extends from the upper edge 35 to a curved edge 37 defining a transition between the inclined surface 36 and the concave surface portion 32.

The injection orifices of the fuel injector 6 are in the second embodiment arranged so that fuel spray 25 is injected toward target positions on, below or above the annular ridge 20, which target positions are located below the protrusions 31, in the shown embodiment below the innermost edge 33. As the ignited fuel spray 25, i.e. the flame, strikes the target positions, the flame is split on the annular ridge 20 into an upper flow portion 25a and a lower flow portion 25b. The upper flow portion 25a of the flame is deflected upward, toward the concave surface portion 32. The lower flow portion 25b of the flame is deflected downward, into the annular channel 26 and toward the central bottom portion 16. As the upper flow portion 25a of the flame impinges on the innermost edge 33 of the protrusion 31, it is split into a first portion 25a′ following the convex surface portion 34 and a second portion 25″ following the concave surface portion 32. Both portions 25a′, 25a″ are deflected toward a position within the upper part of the combustion chamber 5 above the annular ridge 20, which position is angularly spaced from protrusion 31 on which the flame was deflected. The deflected upper flow portions of the flames thereby together induce a swirl motion in the direction of rotation R in the upper part of the combustion chamber 5. Between the lower part of the combustion chamber 5, below the annular ridge 20, and the upper part of the combustion chamber 5, turbulence may be created as the rotating flow of fuel/air mixture in the upper part of the combustion chamber 5 interacts with the fuel/air mixture in the lower part of the combustion chamber 5, which rotates with an axis of rotation perpendicular to or essentially perpendicular to the central axis C.

In the embodiment shown in FIGS. 6-10, the ignition delay may be expected to be relatively short due to the relatively narrow protrusions 21. The relatively short ignition delay is expected to result in a reduced amount of NOx gases created during combustion, but instead the soot emissions may be somewhat increased in comparison with longer ignition delays.

In a method according to an embodiment of the present invention, carried out in the internal combustion engine described with reference to FIG. 1, a flow of air is provided into the combustion chamber 5 during an intake stroke of the piston 2 via the intake port 7 and the intake valve 8. During a subsequent compression stroke of the piston 2, a fuel spray 25 is injected by the fuel injector 6 toward the plurality of target positions, so that the fuel spray 25 is at each one of the target positions split by the annular ridge 20 into an upper flow portion 25a and a lower flow portion 25b. The upper flow portion 25a is deflected by at least the concave surface portion 22, 32 of the protrusion 21, 31 located above the target position, so that a swirl motion is created in the combustion chamber 5.

FIG. 10 shows rotational velocity w as a function of distance r from the central axis C of the piston 2 at the end of injection. As can be seen, the large scale swirl motion created during fuel injection leads to large variations in the rotational velocity w depending on the distance r from the central axis. During the post oxidation phase, the large scale swirl motion created in the combustion chamber 5 may be fractured into small scale turbulence leading to accelerated soot oxidation and thereby lower soot emissions.

The invention is of course not in any way restricted to the embodiments described above. On the contrary, many possibilities to modifications thereof will be apparent to a person with ordinary skill in the art without departing from the basic idea of the invention such as defined in the appended claims.

1. A piston for an internal combustion engine, wherein the piston has an upper end and a lower end between which a central axis and a peripheral envelope surface extend, wherein the upper end comprises an annular top surface defining a plane; and
a piston bowl configured to form part of a combustion chamber, wherein the piston bowl is recessed with respect to the annular top surface, and wherein the piston bowl comprises:
an annular bottom portion defining a lowest level of the piston bowl;
a central bottom portion which is located radially inside of the annular bottom portion and which is elevated with respect to the lowest level;
an annular upper side wall portion extending downward and radially inward from the top surface;
an annular lower side wall portion extending upward from the annular bottom portion toward the annular upper side wall portion;
an annular ridge formed in a transition between the annular upper side wall portion and the annular lower side wall portion, projecting toward the central axis; and,
a plurality of angularly spaced protrusions, protruding toward the central axis from the annular upper side wall portion, each protrusion having a respective concave surface portion,
wherein the piston bowl is configured so that a fluid spray injected toward a target position located below one of said angularly spaced protrusions is split by the annular ridge into an upper flow portion and a lower flow portion, wherein the upper flow portion is deflected by the concave surface portion of the protrusion located above the target position so that it contributes to creation of a swirl motion in the combustion chamber.

2. The piston according to claim 1, wherein the concave surface portion of each of the angularly spaced protrusions is configured to face radially inward.

3. The piston according to claim 1, wherein the concave surface portion of each of the angularly spaced protrusions is configured so that at least a part of the upper flow portion is redirected toward a position above the annular ridge.

4. The piston according to claim 1, wherein each of the angularly spaced protrusions has an innermost point located at a radial distance from the central where such radial distance is within a range of 10% of a radial distance between an innermost point of the annular ridge to the central axis.

5. The piston according to claim 1, wherein the annular lower side wall portion is in the form of a concave surface free from protrusions.

6. The piston according to claim 1, wherein each of the angularly spaced protrusions further comprises a convex surface portion located opposite the concave surface portion.

7. The piston according to claim 1, wherein the central bottom portion has a highest point located on the central axis, from which highest point the central bottom portion slopes downward toward the annular bottom portion.

8. An internal combustion engine comprising at least one cylinder with a piston comprising:
an upper end and a lower end between which a central axis and a peripheral envelope surface extend, wherein the upper end comprises an annular top surface defining a plane; and
a piston bowl configured to form part of a combustion chamber, wherein the piston bowl is recessed with respect to the annular top surface, and wherein the piston bowl comprises:
an annular bottom portion defining a lowest level of the piston bowl;
a central bottom portion which is located radially inside of the annular bottom portion and which is elevated with respect to the lowest level;
an annular upper side wall portion extending downward and radially inward from the top surface;
an annular lower side wall portion extending upward from the annular bottom portion toward the annular upper side wall portion;
an annular ridge formed in a transition between the annular upper side wall portion and the annular lower side wall portion, projecting toward the central axis; and
a plurality of angularly spaced protrusions protruding toward the central axis from the annular upper side wall portion, each protrusion having a respective concave surface portion,
wherein the piston bowl is configured so that a fluid spray injected toward a target position located below one of said angularly spaced protrusions is split by the annular ridge into an upper flow portion and a lower flow portion, wherein the upper flow portion is deflected by the concave surface portion of the protrusion located above the target position so that it contributes to creation of a swirl motion in the combustion chamber.

9. The internal combustion engine according to claim 8, further comprising an injector configured to inject and direct a fluid spray toward a plurality of target positions, wherein each target position is located below one of said angularly spaced protrusions.

10. The internal combustion engine according to claim 9, wherein the internal combustion engine is a diesel engine and wherein the injector is a fuel injector.

11. A motor vehicle comprising an internal combustion engine according to claim 8 comprising at least one cylinder with a piston comprising:
an upper end and a lower end between which a central axis and a peripheral envelope surface extend, wherein the upper end comprises an annular top surface defining a plane; and
a piston bowl configured to form part of a combustion chamber, wherein the piston bowl is recessed with respect to the annular top surface, and wherein the piston bowl comprises:
an annular bottom portion defining a lowest level of the piston bowl;
a central bottom portion which is located radially inside of the annular bottom portion and which is elevated with respect to the lowest level;
an annular upper side wall portion extending downward and radially inward from the top surface;
an annular lower side wall portion extending upward from the annular bottom portion toward the annular upper side wall portion;
an annular ridge formed in a transition between the annular upper side wall portion and the annular lower side wall portion, projecting toward the central axis; and
a plurality of angularly spaced protrusions protruding toward the central axis from the annular upper side wall portion, each protrusion having a respective concave surface portion,
wherein the piston bowl is configured so that a fluid spray injected toward a target position located below one of said angularly spaced protrusions is split by the annular ridge into an upper flow portion and a lower flow portion, wherein the upper flow portion is deflected by the concave surface portion of the protrusion located above the target position so that it contributes to creation of a swirl motion in the combustion chamber.

12. The motor vehicle according to claim 11, wherein the motor vehicle is a heavy motor vehicle.

13. A method for creating a swirl motion in a combustion chamber of a cylinder in an internal combustion engine, wherein the combustion engine comprises at least one cylinder with a piston comprising:
an upper end and a lower end between which a central axis and a peripheral envelope surface extend, wherein the upper end comprises an annular top surface defining a plane; and
a piston bowl configured to form part of a combustion chamber, wherein the piston bowl is recessed with respect to the annular top surface, and wherein the piston bowl comprises:
an annular bottom portion defining a lowest level of the piston bowl;
a central bottom portion which is located radially inside of the annular bottom portion and which is elevated with respect to the lowest level;
an annular upper side wall portion extending downward and radially inward from the top surface;
an annular lower side wall portion extending upward from the annular bottom portion toward the annular upper side wall portion;
an annular ridge formed in a transition between the annular upper side wall portion and the annular lower side wall portion, projecting toward the central axis; and
a plurality of angularly spaced protrusions protruding toward the central axis from the annular upper side wall portion, each protrusion having a respective concave surface portion,
wherein the piston bowl is configured so that a fluid spray injected toward a target position located below one of said angularly spaced protrusions is split by the annular ridge into an upper flow portion and a lower flow portion, wherein the upper flow portion is deflected by the concave surface portion of the protrusion located above the target position so that it contributes to creation of a swirl motion in the combustion chamber,
wherein said method comprises:
providing a flow of air into the combustion chamber during an intake stroke of the piston; and,
during or after a compression stroke of the piston, injecting a fluid spray toward the plurality of target positions, so that the fluid spray is at each one of the target positions split by the annular ridge into an upper flow portion and a lower flow portion, wherein the upper flow portion is deflected by the concave surface portion of the protrusion located above the target position so that a swirl motion is created in the combustion chamber.

14. The method according to claim 13, wherein the internal combustion engine is a diesel engine and wherein the injector is a fuel injector, wherein injecting a fluid spray comprises, following a compression stroke of the piston, injecting a fuel spray so that when the fuel spray is ignited and a flame is formed, at least an upper flow portion of the flame is deflected by the concave surface portion so that a swirl motion is created in the combustion chamber.

15. The method according to claim 13, wherein the flow of air into the combustion chamber is provided independent of creating a swirl motion.
